(19) United States
(12) Patent Application Publication
(10) Pub. No.: US 2007/0268113 A1
(43) Pub. Date: Nov. 22, 2007

(54) Detunable Rf Tags

(76) Inventor: Daniel R. Johnson, Worcestershire (GB)

Correspondence Address: NIXON & VANDERHYE, PC, 901 NORTH GLEBE ROAD, 11TH FLOOR, ARLINGTON, VA, 22203, US

(21) Appl. No.: 11/666,739

(22) PCT Filed: Nov. 3, 2005
(86) PCT No.: PCT/GB05/04264

§ 371 Date: May 2, 2007

(30) Foreign Application Priority Data
Nov. 5, 2004 (GB) 0424499.2
Jan. 21, 2005 (GB) 0501241.4

(51) Int. Cl. G08B 13/14; H04Q 5/22

(52) U.S. Cl. 340/10.1

(57) ABSTRACT

An RF tag suitable for use for electronic article surveillance comprises a tuned circuit formed by an inductive coil, which behaves as an antenna on a first side of a substrate electrically connected to a capacitor having plates on each side of an dielectric layer which may be the substrate. The capacitor and coil together form a resonant circuit. To permit deactivation of the tag the circuit also includes a discontinuity closed by a switch composition whose conducting properties can be changed from an insulating state to a conducting state when the tag is subjected to a strong electric field at or around its resonant frequency. The switch composition may, for example, be arranged to short out the capacitor plates or introduce additional capacitor plates or change the properties of the inductive coil. Alternatively the switch composition may introduce additional components (e.g. an IC) into the circuit. The tag may be arranged for sequential retuning to give a multifrequency tag. The switch composition may, for example, be an ink formulation containing 5 to 75% by weight a metal, preferably in the form of flakes. The switch composition may further contain oxygen scavengers or ionic species to improve the response of the switch composition and/or prevent the switch composition reverting to the insulating state.

### FIELD OF THE INVENTION

The invention relates to radio-frequency (RF) tags which are capable of being detected by an external electric field and in particular to RF tags which can be activated, retuned/detuned and/or deactivated. Such tags are frequently used for Electronic Article Surveillance (EAS) to detect unauthorized articles being removed from enclosed areas such shops or libraries.

Simple “one bit” EAS RF tags typically comprise a tuned circuit having inductive and capacitor components. A detector “gate” is arranged at the exit to the enclosed area and coils within the gate generate an electrical field at the resonant frequency of the tag. If the tag passes through the gate the field is disrupted and circuitry attached to the gate detects this disruption, which generates a signal which may in turn trigger an alarm. In practice the gate frequency commonly scans frequencies around the expected resonant frequency to allow for manufacturing variations in the tag.

To permit authorized removal of an article from the enclosed area the tag is de-activated. For example tags on goods are deactivated at the point of sale, so that only goods which have not been paid for activate the alarm. Additionally there is a need for tags which can operate at more than one resonant frequency for example to record successive movements articles or use of passes.

### DESCRIPTION OF THE PRIOR ART

Known RF EAS tags commonly comprise as the inductive element an antenna coil, typically a metal such as aluminium or copper, formed on a dielectric substrate by coating the substrate with a metal, applying an etch resist in the pattern of the desired coil and etching away the remaining metal. The etch resist pattern also includes an area electrically connected to the antenna which acts as one plate of a capacitor. On the opposite side of the substrate there is applied, by a similar technique, the second plate of the capacitor substantially aligned with the first plate and connected by a conducting track to a point on the second side of the substrate aligned with the end of the antenna remote from the first plate on the first side of the substrate. An electrical connection is then made between the two sides of the substrate either at the edge or through a hole to complete the inductance/capacitance circuit. This through connection may be made by any conventional means such as soldering, but may simply be effected by crimping the two metal tracks so that they form a sound electrical contact.

Alternatively it is known from U.S. Pat. No. 6,373,387 to form the tag on one side of a flexible substrate which is then folded to align the two plates of the capacitor.

U.S. Pat. No. 4,567,473 describes a technique permitting the tag to be de-activated, wherein an area of one or both capacitor plates is punched or crimped to form a weak point in the dielectric substrate. To de-activate the tag it is subjected to a very high field at the resonant frequency which results in a high current causing breakdown of the dielectric substrate at this weak point thus shorting out the capacitor and eliminating the resonant response of the circuit. The tag will then no longer be detected by the lower field of the gate and thus will not trigger the alarm when passed through the gate.

This method of forming the fuse is known to be unreliable, presumably due to poor reproducibility of the weakening step. Hence many tags are either shorted during the manufacturing process or fail to blow at the point of sale or re-activate some moments later after blowing. Reliability of manufacture may be as low as 50%.

U.S. Pat. No. 3,967,161 describes an alternative structure wherein part of the resonant circuit comprises a fusible link formed of a narrowed or necked-down portion which melts to break the circuit when subjected to the de-activating field. U.S. Pat. No. 4,385,524 describes a variant of this wherein the fusible link comprises a gap closed by a fusible link such as graphite, carbon black, silver, copper, aluminium, or gold optionally containing an accelerator. However in such structures the fusible link forms part of the resonant circuit and so the impedance will affect the resonant frequency and so needs to be closely controlled. Moreover since the fusible link forms part of the resonant circuit and so adds series resistance to the circuit which reduces impedance at the resonant frequency. This manifests as a poor resonant response which in turn influences the read range of the device at a given field strength or gate separation. Variations in the manufacture, storage or service of the fusible link may give rise to fluctuations in resistance and hence the field strength needed to fuse the link. In some instances the fusible link may be prone to mechanical damage resulting in shorter read range or the gates blowing the fusible link. If the fusible link becomes broken at any stage prior to de-activation it would render the device unreadable.

It is also known to provide electronic switches within the tag to change the resonance of the circuit. For example European Patent 1429301 describes a tag having a reversible switch such as a field effect transistor in the circuit or between the plates of the capacitor. However such systems are inherently expensive to manufacture, often requiring memory elements in addition to the switch itself, and unsuited to low cost, high volume tags.

There is therefore a requirement for an alternative design of deactivator which can be activated by RF means and can be manufactured cheaply and reliably.

### GENERAL DESCRIPTION OF THE INVENTION

The invention provides a substantially non conducting switch composition suitable for use in RF tags, which can change its conductance sufficiently when subjected to an RF field to change the characteristics of the circuit, which in turn will change the resonant frequency of the RF tag.

According to the invention there is provided an RF tag comprising a tuned circuit formed by an inductive coil, which behaves as an antenna on a first side of a substrate and electrically connected to a first capacitor plate on the same side of the substrate as the inductive coil said inductive coil being electrically connected to a second capacitor plate substantially aligned with the first capacitor plate but separated from the first capacitor plate by a dielectric layer, characterized in that the circuit also contains an insulating gap to which has been applied a switch composition whose conducting properties can be changed from an insulating state to a conducting state when the tag is subjected to a strong electric field at or around its resonant frequency. Conveniently the dielectric layer may be the substrate and the second capacitor plate may be located on the second side of the substrate and connected to the coil by a conducting track and an electrical connection through the substrate. Alternatively the first and second conducting tracks may be on the same side of the substrate and the dielectric layer may be a separate layer, for example as described in the above US Patent Applications.

It is believed (although then invention is not limited by this explanation) that the strong electric field generates a high potential across the switch composition which in turn is effective to convert the composition from the insulating to the conducting state.

The insulating gap may be placed at any convenient point on the circuit. The switch composition when in its insulating state has no substantial effect on the tuned circuit. However when converted to its conducting state it changes the resonance of the circuit. This change may be to a deactivated state or to another resonant frequency.

Alternatively or additionally the change of conductance may introduce further electrical components, such as integrated circuits or memory chips into the circuit to change the characteristics of the tag.

The energy of the RF signal applied to the device, to cause a change in the switch composition, may be substantially the same as that commonly used to deactivate RF tags. The voltage at which switch composition switches may be selected depending on the available voltage.

Optionally the circuit may contain more than one insulating gap to which has been applied the same or different switch compositions. When the switch composition in the first insulating gap has been caused to change to a conducting state, and the configuration of the circuit is such that a second resonant frequency has been achieved the tag may be interrogated with a low power RF transmitter and detector, such as those commonly employed in the prior art operating at the second resonant frequency.

Conveniently, the power of the interrogating RF transmitter and detector will not be sufficient to cause further change in the conductance in the switch composition. However application of higher power at the second resonant frequency may induce a further change of conductance in the switch composition or a change in the conductance of a switch composition in a second insulating gap to convert the tag to a third resonant frequency. This process may be repeated to generate further resonant frequencies.

According to one embodiment of the invention, the insulating gap may be between conducting tracks connected to the first and second capacitor plates by-passing the inductive coil. The switch composition when in its insulating state has no substantial effect on the tuned circuit. However when converted to its conducting state it shorts the capacitor and damps, re-tunes or eliminates the resonance of the circuit.

According to an alternative embodiment the switch composition may be between one or more further capacitor plates. Such that when the composition is activated the one or more further capacitor plates are introduced into the circuit, which changes the capacitance of the circuit, There may be a plurality of capacitor plates joined to the first or second capacitor plate by one or more switch composition. For example the second capacitor plate may be aligned with only part of the first capacitor plate and a third capacitor plate, separated from the second capacitor plate by an insulating gap closed by a switch composition, may be aligned with the remainder of the first capacitor plate. Alternatively the third capacitor plate may be aligned with a fourth capacitor plate separated from the first capacitor plate by an insulating gap closed by a further switch composition. Conversion of the switch composition or compositions from insulating to conducting will introduce the additional plate or plates in parallel with the first and second capacitor plates, thus increasing the capacitance and changing the resonant frequency of the tag circuit. It will be apparent that by the use of a series of capacitor plates connected by the same or different switch compositions a tag may be constructed which can be sequentially activated to resonate at a series of frequencies.

According to an alternative embodiment the insulating gap may be between two points on the inductive coil. When converted to its conducting state the switch composition will reduce the number of effective turns in the coil and hence reduce the inductance of the coil and alter the resonant frequency of the tag. Alternatively the switch composition may be between the coil and a further inductive coil or series of inductive coils so that conversion of the switch composition to its conductive state increases the number of effective coils present and hence increases inductance. For example the further inductive coil may be further turns outside or inside the original inductive coil.

In a second aspect of the invention an RF tag comprising a plurality of tuned circuits, wherein one or more circuits may be caused to change from a first resonant frequency to a second resonant frequency or to a non resonate state ( for example damped), by subjecting said tag to an RF frequency corresponding to the first resonant frequency. The RF tag may comprise an array of individually tuned circuits each possessing discrete inductance coils and capacitors tuned to different frequencies. The individual tuned circuits may be arranged in a substantially coplanar array or stacked or in any other convenient configuration. These individual RF circuits may be written to using strong RF fields operating at set frequencies. These may be used to deactivate some of the resonant circuits (zeros) and others may be retained in the activated state (ones) to create a binary string of resonance data similar to an optical bar code. The dimensions and read range of these arrays would be made to suit the particular application. . In an alternative arrangement the RF tags may be built up in successive layers on only on side of the substrate, by applying an insulating layer over the first tag and then applying subsequent RF tags to build up a layer structure.

A third aspect of the invention provide a method of activating a tag as hereinbefore defined comprising the steps of i) selecting a resonant frequency of one or more circuits ii) causing said circuit to change from a first resonant frequency to a second resonant frequency or non resonant state; iii) repeating steps i) and ii) to cause a unique combination of resonant frequencies in said activation tag; iv) transmitting a plurality of low power RF signals capable of causing resonance in the plurality of tuned circuits in said RF tag v) detecting the presence of said resonant frequencies.

In a further embodiment, the RF tag may be changed to new frequencies sequentially in an additive manner. This may be used to provide information, such as, for example, the number of interactions with a tag reader, or to detect if the tag was deactivated by tampering.

It should be understood that conducting and insulating are relative terms. For example the conductance in the conducting state does not need to be as high as a typical metallic conductor. All that is required is for the difference in conductance to change the impedance or tuning of the circuit sufficiently to change its response to the detector gate. In some cases it may be preferable that the resistance of the switch composition in its conductive state is very low so that the resonant circuit remains essentially an inductive-capacitive (LC) circuit. In other cases it may be preferable to control the conductance in the conducting state as this will introduce a resistive element creating an inductive/capacitive/resistive (LCR) circuit to damp the resonance of the tuned circuit.

In principle any metal can be used, provided it can be produced as particles and preferably flakes or needles which are inert in air and the binder formulation. Suitable metals include aluminium, copper, iron, steel, zinc, titanium and especially nickel. The metal should typically comprise between 5 and 75% (weight/weight) of the cured switch composition after removal of solvent.

Where the fuse composition is to have a high resistance (low conductance) in the conducting state the metal content is preferably between 5 and 25% (weight/weight) of the cured switch composition. When the total loading of metal particle is low the impedance is low at the new resonant frequency. The tag may not be detected by reader devices. Thus the tag could be described as deactivated or heavily damped if connecting a further capacitor plate.

When the metal loading is significantly low in the switch composition, the connection created between the RF circuit and the electrical component, such as for example the capacitor plate; will have increased resistance. The new resistor and capacitor component acts as an electronic damper to resonance and the electrical energy is instead absorbed in the resistive component.

Alternatively, if the metal particle loading is higher, for example 25 to 75% by mass in the cured composition, the resistance is not a significant factor to the circuit. Therefore when using high metal loadings the effect is to create a low resistance electrical connection. The tag may then be read by a reader device tuned to the new frequency.

The optimum metal content will depend on the identity and physical form of the metal and also other factors such as the frequency and strength of the field to be used to detect and blow the tag and whether recovery of the tag is required and if so the period for recovery and its extent. The ideal composition in any given case may readily be determined by routine experimentation.

The selection of the percentage weight inclusion of metal loaded into the switch composition may determine the resistance of the composition when it has been caused to change to its conductive state.

Preferably the dimensions of the conducting particles is in the range of from 0.1 to 1000 μm, more preferably in the range of from 1 to 100 μm although it will be understood that in many cases the particles may be planar (that is with dimension in the z dimension substantially less than the x and y dimensions) or needle-like (z and y dimensions less than x dimension) rather than spherical.

The switch composition may be added to a formulation suitable for printing on the substrate to be coated.

According to a further aspect of the invention there is provided a switch composition suitable for carrying out the method according to the invention whose conducting properties can be changed from an insulating state to a conducting state when subjected to a high electrical potential. Accordingly there is further provided a switch composition suitable for an RF tag whose conducting properties can be changed from an insulating state to a conducting state when subjected to an electrical potential, wherein the switch composition comprises a binder and a plurality of conducting particles having an insulating surface layer, wherein substantially all of said particles are in contact with adjacent particles, such that when subjected to an electrical potential break down of the insulating surface layer creates a conducting path.

The switch composition may conveniently be applied as a composition which may include a volatile solvent and a binder. Suitable volatile solvents include water, alcohols, ketones, ethers and other volatile organic solvents. Suitable binders include organic polymers such as polyvinyl alcohol, polyvinylacetate, polyamides, polyethers, polyurethanes, UV curable monomers and oligomers and hotmelt adhesives. Other suitable binder as conventionally used in printing inks will be apparent to the skilled man.

It will be understood that this aspect of the invention is not limited to RF tags, but may be used in any electrical circuit where it is required to link two circuit elements and to change conductance of that link by application of an applied electrical field or voltage.

The switch composition has been found to be much more reliable in changing the characteristics of the capacitor in an RF tag than the weakened dielectric of the prior art. However as the switch composition need not form part of the resonant circuit its electrical properties are less critical than a fusible link in the resonant circuit.

The change of conductance may be permanent or reversible, either with time or by the application of an external stimulus. Hence tags may be produced which can be repeatedly activated and de-activated unlike the “one-shot” RF tags used previously.

In one embodiment of the present invention the switch composition comprises a substantially non-conducting binder formulation, such as an ink containing conducting particles, preferably metal or metal alloy. However the conducting particles may be metalloid or other conducting materials such as graphite or conducting polymer. Preferably the particles are in the form of flattened or elongated particles such as flake or needles. There may be more than one type of conducting particles present in the switch composition.

The switch composition may contain a plurality of conducting particles which when sufficiently spaced form an insulating composition. The conducting particles will advantageously have a non conducting layer on their outer most surface, this may conveniently take the form of an oxide coating.

The conductance value of the switch composition in its conductive state is dependent on the metal particle loading, the shape of the particle and the dielectric properties of the insulating layer in the switch composition. It is preferable to use metal flakes to limit the total loading of this component in the ink.

It is believed (although the invention is not limited by this explanation) that most metal particles will have an oxide coating and depending on the concentration in the switch composition particles will be out of contact with each-other. On applying a strong RF field the induced potential will mean that the oxide layers and gaps between the particles will be overcome to provide a conductive path. Chemical reducing agents or oxygen scavengers may be added to improve the oxide reduction mechanism. Further examples of surface insulating layers that may be used are chemically bonded may be nitride or sulphide layers.

Alternatively other surface coatings, which may be overcome by the action of an RF field, may be used. The insulating layer may be physically adsorbed, chemically bonded or electrostatically attracted to the conducting particle, by way of example only, such insulating layers may conveniently be, for example, hydroxide or halide. Examples of adsorbed or coated insulating layers are silicas, organic compounds, or de-wetting agents. Preferably the insulating surface layer is an organic compound or de-wetting agent (commonly referred to as a leafing agent), such as for example stearic acid or oleic acid. Conveniently certain flake or micronized metal powders may be provided with a de-wetting agent to assist in their handling; this coating may provide sufficient insulating properties to cause an insulating layer. Alternatively further organic compounds or thicker layers of de-wetting agents may be applied to the conducting particles to adjust the voltage required to cause the insulating layer to break down.

In the case of RF tags, the RF tag deactivating system is only able to generate(induce in the circuit) a fairly modest voltage due to health and safety issues. Therefore the thickness of the insulating layer may be selected such that it is able to break down to form a conducting path at the required voltage. In a preferred embodiment for RF tag systems the thickness the insulating surface layer may be less than 10 micron, preferably less than 1 micron. Conveniently, for conducting particles which are in the range of a few microns the insulating surface layer may be less than 100 nm, yet more preferably less than 50 nm.

Additionally ionic species may be added to the switch composition ink to improve cross-connection between particles or invoke electrochemical processes.

Over a period of time in an oxygen-containing environment such as air the switch compound comprising materials with an oxide insulating coating may be found to revert to an insulating state and re-activate the tag. This is believed (although the invention is not limited by this explanation) to be because the metal particles will tend to re-oxidize. The speed at which this occurs will depend on a number of factors such as temperature, oxygen content and reduction or oxidation chemistry associated with the ink and the materials it attaches to (e.g. galvanic corrosion set up between the metal used in the fuse ink and the metal associated with the metal tracks or capacitor plate). However the nature of the binder formulation is likely to influence this rate so that fuse compositions of varying recovery time can be formulated by controlling the binder composition. The binder may selected such that the metal is not able to re-oxidize, the ink may optionally include a oxygen scavenger to prevent re-oxidation, or metal particles with the same galvanic potential as the metal in the circuit, this would provide a one-use device which is unlikely to be able to be re-activated.

Alternatively in another embodiment it may be convenient to provide a further component within the ink formulation which is able to re-activate the switch composition, an example of which, would be to include a component which is able to re-oxidize the metal within the switch composition, such that, as soon as the tag has been de-activated the reverse reaction is able to re-oxidize the metal and restore the activity of the RF tag.

The switch composition may be applied to the substrate by any convenient pattern transfer method, such as, for example, printing (ink jet, litho or any other conventional printing method) or simply by dropping the fuse composition onto the tag. Preferably the switch composition is applied in a curable ink, such as for example a volatile solvent which is later removed by evaporation. Suitable solvents include water and organic solvents.

The switch composition may be incorporated into a conventional printing ink composition with suitable binders designed for the substrate and may include or omit pigments conventional in such inks. Alternatively the switch material may be added to an ink formulation made from materials that solidify by cross-linking in the presence of ultraviolet UV light, an electron beam or other energetic media.

The switch composition or RF tag may also contain a means of visual indication, such that the colour or absorbance of a visual indicator changes when the resonant frequency of the circuit changes. The colour of the indicator may change when the conductance of the switch composition changes. The switch composition may contain or may be coated with spectroscopically active material or fluorescent compounds.

The substrate may be any suitable rigid or flexible dielectric substrate such as, for example, paper, polyethylene, polypropylene, polyimide, polycarbonate, polyesters like PET, structural polymers such as ABS, polymer composites such as epoxy/glass fibre composites (including those known as FR4), or ceramics.

The substrate/and or dielectric may be the switch composition in the non conducting form. When the switch composition is subjected to a strong RF field to cause a change in the conductance of the switch composition, the circuit will short and hence be deactivated. This may provide a very simple one-shot device.

The inductive coil, which forms the antenna and capacitor plates may be applied to the substrate by conventional technology such as applying a metal sheet and then etching the desired patterns, or by printing a conductive ink, but are preferably applied by electroless deposition optionally followed by electrodeposition as more fully described in published International Patent Application WO02/099162.

The use of conducting particles without an insulating layer in a binder system will with sufficient loading give rise to a conducting composition. However, there is no means to switch the conductive nature of the composition other than physical removal. Similarly, if conducting particles without an insulating layer were used at a loading insufficient to cause conductance, then their conductance could be altered by the electrical breakdown of large portions of the binder between adjacent conducting particles. However, this would require very significant amounts of energy to carbonize the binder, which may not be suitable for RF tag systems. Therefore simple conducting particles without an insulating or dielectric layer may not be particularly useful as switches in electronic devices where large voltages are unavailable.

### BRIEF DESCRIPTION OF THE DRAWINGS

The invention will be further described with reference to the enclosed drawings in which;

FIGS. 1A, 1B and 1C show a tag according to the invention having the switch composition between the plates of the capacitor;

FIGS. 2A, 2B and 2C show a tag according to the invention having the switch composition across substantially all turns of the coil; and

FIG. 3 shows the curve of impedance against frequency for the tag shown in FIG. 1C before and after application of a field to “blow” the tag by rendering the switch composition conducting.

FIGS. 4a-b show the two sides of a tag according to the invention having switch composition between the second capacitor plate and a third capacitor plate.

FIGS. 5a-b show examples of possible configurations of further tags in relation to a first tag.

FIG. 6 shows an identification tag with an array of RF tags

FIGS. 7a-c show the curve of impedance against frequency for the tag shown in FIG. 4a with high and low metal loadings.

### DETAILED DESCRIPTION OF THE DRAWINGS

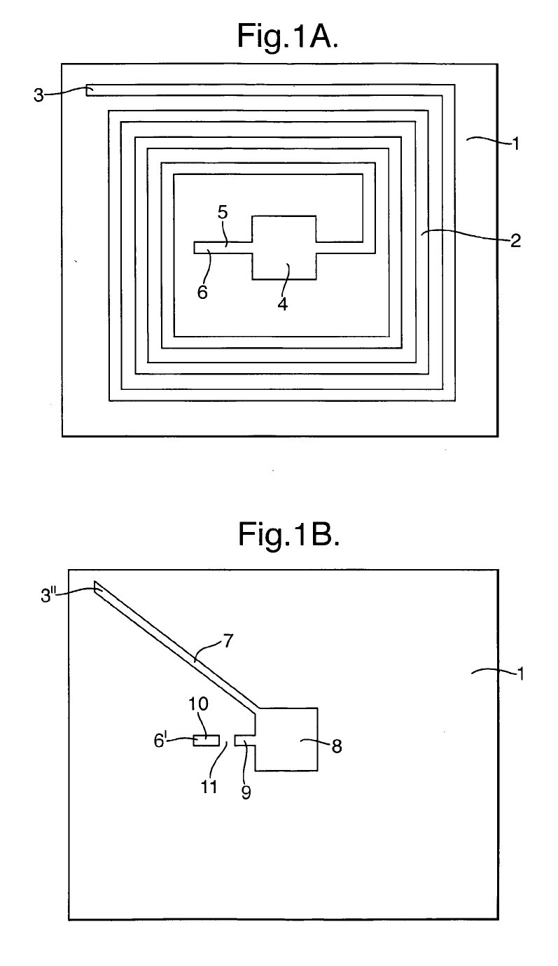

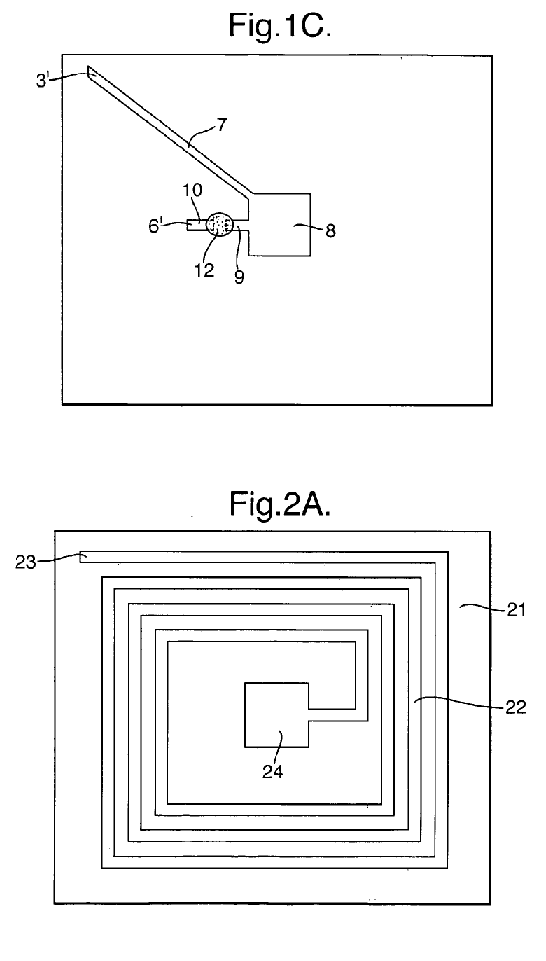

FIG. 1A shows the first surface of a tag comprising a polypropylene substrate 1 on which a conducting pattern of copper has been printed by electroless printing as. described in published international patent application WO02/099162 followed by electroplating to thicken the coating.

The pattern comprises a coil 2 forming an antenna. For convenience only a few turns of the coil are shown. In an actual tag there may be more depending on the inductance required. The coil 2 spirals inwards from a point 3 close to the outer edge of the surface towards the centre where it makes electrical contact with a first plate 4 of a capacitor also forming part of the conducting pattern. Also forming part of the conducting pattern is a first extension track 5 which extends from the first plate 4 and terminates at a point 6 on the first surface separate from the coil 2 or the first plate 4.

FIG. 1B shows the second surface of the same tag on which a second conducting pattern has been applied by a similar process. This further conducting pattern comprises a conducting track 7 starting at a point 3′ opposite point 3 on the first surface and passing diagonally inwards to connect with a second plate 8 of the capacitor opposite and substantially aligned with the first plate 4. From the second plate 8 a second extension track 9 and 10 extends to a point 6′ on the second surface opposite point 6 on the first surface. However this second extension track consists of two sections 9 and 10 separated by an insulating gap 11.

Connections are made through the substrate 1 at points 3/3′ and 6/6′ to provide electrical connection between the two conducting patterns either by crimping or by creating a hole prior to electroless plating so that catalyst enters the hole and metal is deposited in the hole during electroless and/or electroplating

FIG. 1C shows the second surface of the tag after a switch compound 12 has been applied across the gap (covered) by dropping a liquid switch composition across the gap followed by hot-air drying.

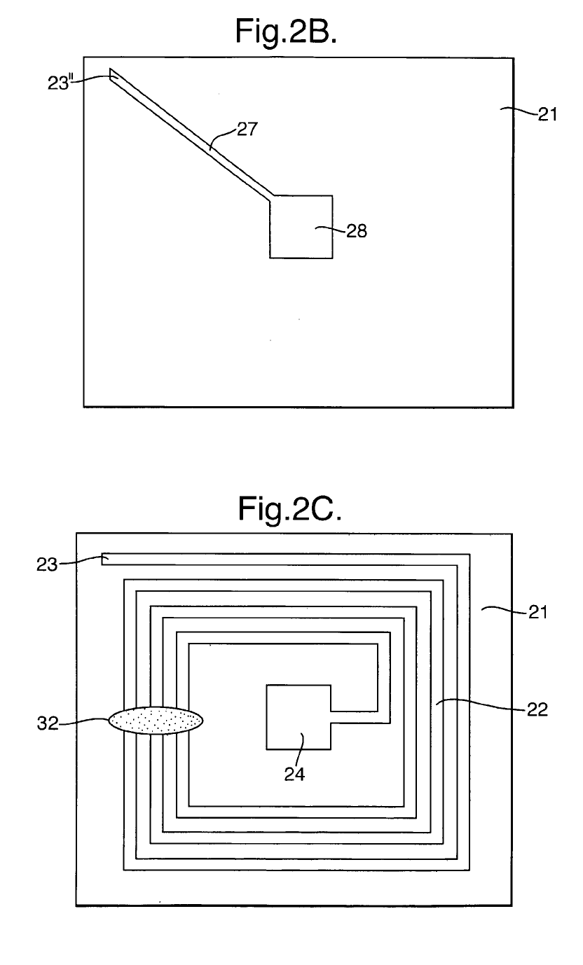

FIG. 2A shows the first surface of a tag comprising a polypopylene substrate 21 on which a conducting pattern of copper has been printed by electroless printing as described in published international patent application WO02/099162 followed by electroplating to thicken the coating.

The pattern comprises a coil 22 forming an antenna. For convenience only a few turns of the coil are shown. In an actual tag there may be more depending on the inductance required. The coil 22 spirals inwards from a point 23 close to the outer edge of the surface towards the centre where it makes electrical contact with a first plate 24 of a capacitor also forming part of the conducting pattern.

FIG. 2B shows the second surface of the same tag on which a second conducting pattern has been applied by a similar process. This further conducting pattern comprises a conducting track 27 starting at a point 23′ opposite point 23 on the first surface and passing diagonally inwards to connect with a second plate 28 of the capacitor opposite and substantially aligned with the first plate 24.

Connections are made through the substrate 21 at point 23/23′ to provide electrical connection between the two conducting patterns either by crimping or by creating a hole prior to electroless plating so that catalyst enters the hole and metal is deposited in the hole during electroless and/or electroplating

FIG. 2C shows the first surface of a tag device after a switch compound 32 has been applied across substantially all turns of the coil 22 by dropping a liquid switch composition across the gap followed by hot-air drying.

It will be understood that to provide a deactivatable tag in accordance with the present invention it is not necessary to deposit the switch composition 23 across all turns of the coil 22, but merely across two or more turns.

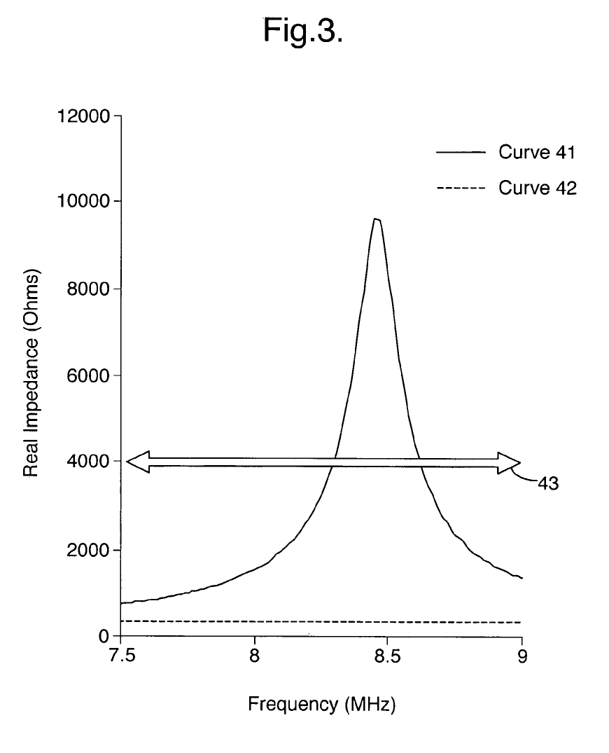

In FIG. 3 the two curves show the relationship of the impedance of the tag to frequency. Curve 41 shows the properties of the tag in its “active” form when the switch composition is non-conducting and curve 42 shows the properties of the tag in its de-activated form after the application of a field to render the switch composition conducting. The dark double-ended arrow 43 shows the approximate impedance level required to trigger a typical exit gate. It can be clearly seen that the active tag has a peak impedance easily sufficient to trigger a detection gate whereas after de-activation the impedance is reduced to a very low level insufficient to trigger the detection gate.

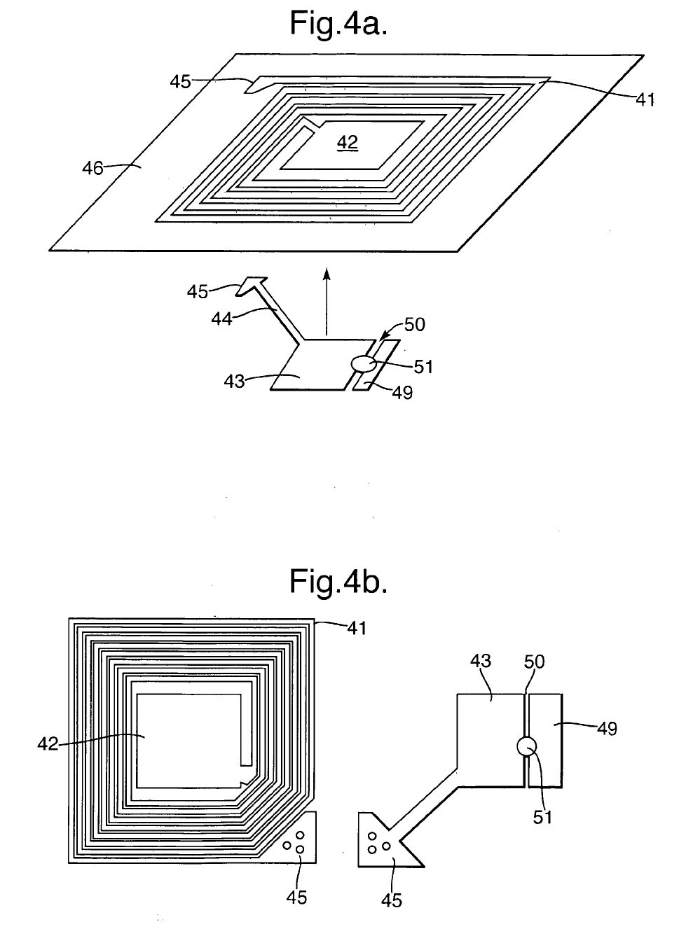

In FIGS. 4a and 4b the tag comprises an inductance coil 41 and first capacitor plate 42 connected via a through hole 45 of the substrate/dielectric 46 to the reverse side of the tag. The through hole is connected to a busbar 44 and second capacitor plate 43 which is aligned and overlapped by the capacitor plate 42 on the front of the tag. The area of this second capacitor plate 43 and the dielectric coefficient of the substrate determine the capacitance of the circuit and hence the resonant frequency of the tag with the inductor loop 41. A third capacitor plate 49 is separated from the second capacitor plate 43 by an insulating gap 50 across which is applied the switch composition ink 51 as hereinbefore described. The third capacitor plate 49 is aligned and overlapped by capacitor plate 42 on the front surface of the tag.

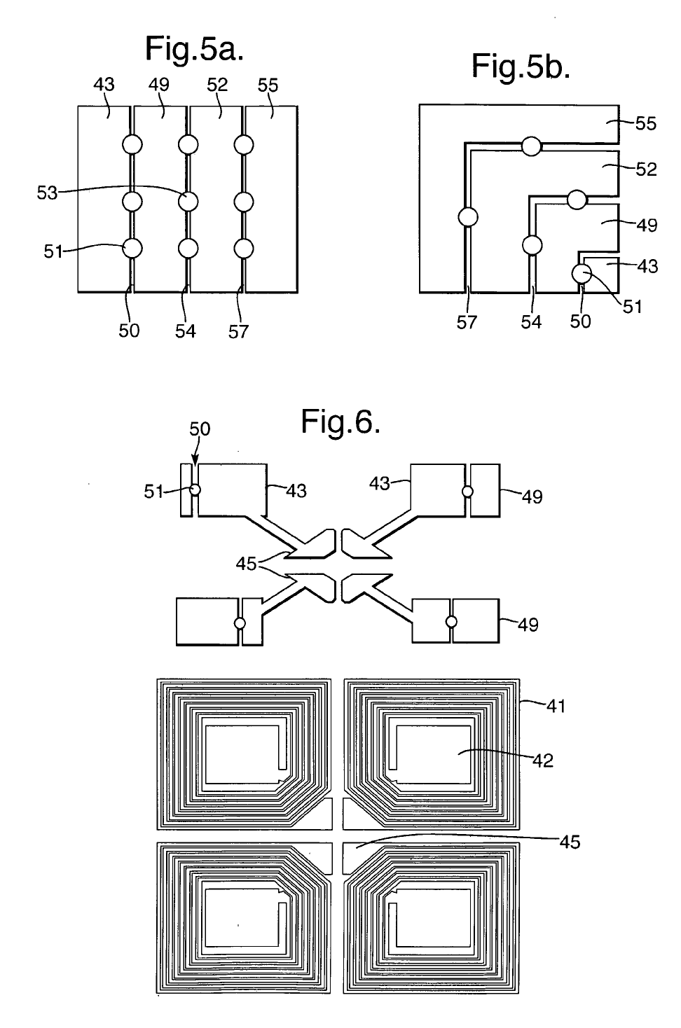

FIGS. 5a and 5b, show a number of configurations of capacitor plates which may replace the second capacitor plate 43 and third capacitor plate 49 in FIG. 4a. The second capacitor plate 43 which is joined to the busbar (not shown) is electrically connected to the third capacitor plate 49, via a first switch composition 51, which spans the gap 50. To ensure good connectivity between adjacent capacitor plates 43 and 49, there may be a plurality of deposits of switch composition 51. Alternatively all of the gap 50 may be filled with switch composition. The third capacitor plate 49 is in turn connected to a fourth capacitor plate 52 via a second switch composition 53 across a further gap 54 and the fourth capacitor plate 52 is connected to a fifth capacitor plate 55 by a third switch composition across a gap 57. The second to fifth capacitor plates 43, 49, 52 and 55 are all aligned opposite the first capacitor plate 42 of FIG. 4a.

FIG. 5b shows that the capacitor plates may be in a substantially different, configuration. The advantage of the shape of the capacitor plates in FIG. 5b is that you can significantly increase or decrease the area and hence capacitance of each new added capacitor plate. It will be apparent that other configurations (for example concentric) may be used.

Conveniently the capacitor plates 42 and 43, 49 etc. may be produced in any desirable shape, such as substantially square, circular, triangular, or polygon. Conveniently the shape may be a split annulus of any cross section, such as for example substantially square, circular, triangular, or polygon.

During the use of this circuit, the capacitor plate 43 and 42 (shown in FIG. 4a) possesses a resonant frequency, determined by the capacitance and inductance of the circuit. To activate the tag, a strong RF frequency, which is tuned to the resonant frequency of the circuit (defined in part by the area of capacitor formed by interaction of the first capacitor plate 42 with second capacitor plate 43) is applied. This will cause a change in conductance of the switch composition 51 and introduce the third capacitor plate 49 into the RF circuit, The creation of a larger capacitor plate (43+49) will re-tune the RF tag to a new resonant frequency. The new frequency is determined by capacitance of the first capacitor plate interacting with the new larger capacitor plate, comprising the area of plates 43 and 49. If a further strong RF frequency is applied at the new resonant frequency (for capacitor plate 43+49) this will introduce capacitor plate 52 and re-tune the tag once more. This process may be repeated once more to activate the fifth capacitor plate 55. This is useful to sequence deactivation events for example where tickets and passes can be adjusted to reflect the users credits. Conveniently a plurality of capacitor plates may be joined in this fashion.

FIG. 6, shows an RF tag having a plurality of tuned circuits arranged in a substantially coplanar array, each with varying capacitor plate areas 43 and 49. Each circuit will initially just use capacitor plate 43, As each capacitor plate 43 has a different area each circuit will posses a different resonant frequency. Similarly each capacitor plate 49 may be a different size. Therefore each circuit may be detuned/retuned by being subjected to a strong RF signal at its resonant frequency. Therefore it is possible to select which circuits are detuned/retuned, using the process hereinbefore described. In effect this creates an RF array which may be used to store binary data by way of their active and deactivated states, which corresponds to their tuned and de-tuned states in a manner analogous to a binary barcode thus replacing the costly solution of silicon chip data storage.

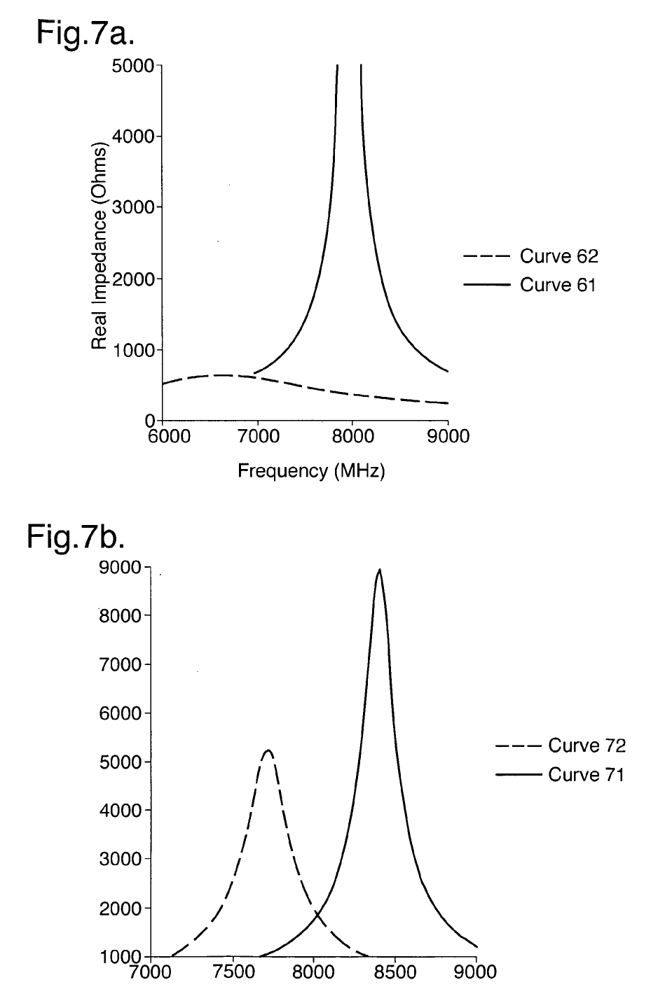

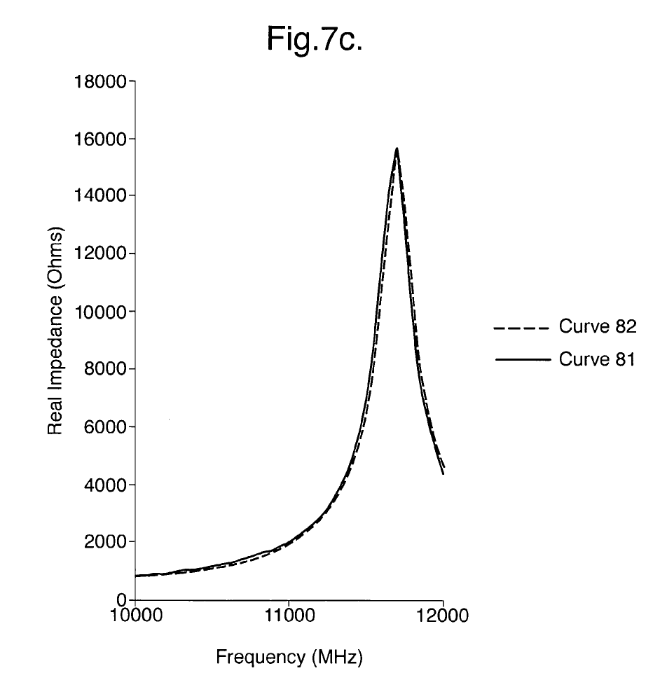

FIG. 7a shows the relationship of impedance to frequency for an RF tag which possesses a third capacitor plate 49 which is electrically connected via a switch composition 51, as shown in FIGS. 4a-b. Curve 61 represents the initial impedance response of the tag. The switch composition in this instance has a low metal loading which when caused to change to its conducting state gives rise to a high resistance circuit. This effectively gives a damped response. Curve 62 is the response of the tag following 1 second of exposure to the deactivation field of a commercially available EAS deactivator approximately tuned to 8 MHz±1 MHz bandwidth. The tag would not able to be read by a checkpoint reader gate and is thus considered deactivated.

FIG. 7b shows the relationship of impedance to frequency for a similar RF tag as used to prepare FIG. 7a, In this instance the switch composition has a high metal loading. The change in conductance of the switch composition introduces a further capacitor plate, such as for example plate 49 (FIG. 4a). Curve 71 represents the initial impedance response of the tag. Following exposure of the tag to a strong RF field, as described in FIG. 7a, curve 72 shows that the impedance has a sufficient magnitude to be read by a reader at the new frequency. This is useful if the change of state is informative.

FIG. 7c shows the relationship of impedance to frequency for a similar RF tag as used to prepare FIG. 7b. The tag had initial impedance represented by curve 81. The tag was subjected to a strong RF field at a frequency which did not match the resonant frequency of the tag. The tag was not deactivated and retained its original resonant frequency response curve 82. Therefore tuned circuits only change state under tuned deactivator conditions.

In the case of electromagnetic RF tags for example UHF dipole antenna, the switch compositions are able to energize in the same way and add conductive elements which adjust the dipole length of the antenna and thus its resonant frequency. The readability and data storage of these devices are the same as those applications described herein.

A wide range of effects and device responses are possible with the present invention and that the principles and designs listed here can be extended to all RF tags and other applications utilizing oscillating signals in an electrical circuit. It is also possible to apply the same to devices substantially constructed onto one surface of a substrate as well as two, for example using multiple printed layers of conductors, semiconductors and dielectrics.

### SPECIFIC EXAMPLES

### Example 1

A tag was constructed in the form shown in FIGS. 1A to 1C. The metal tracks were of copper deposited by electroless plating and thickened by electroplating. The circuits on the two sides were connected by crimping at point 3/3′ and the contact hole 6/6′ was through-plated by the process used to print the metal tracks.

The switch composition 11 was formulated from an aqueous ink (Coates Aqualam screen print varnish) containing 30 weight percent of nickel flake having a sieve size −325 mesh (US standard mesh) and a mean particle size of 30 microns and 0.4 microns thick, supplied by Novamet. The switch composition was dropped onto the substrate and cured with UV light. The tag was connected to a Hewlett Packard 4192A LF impedance analyzer and tested for impedance response to an applied signal over the frequency range 7.5 to 9 MHz The resulting trace is shown at curve 41 in FIG. 3. This tag was found to trigger the alarm at a standard detector gate operating on a swept frequency around 8 MHz.

The tag was then passed over a “Crosspoint XRDA-3” tag blower which subjected it to swept high field strength at around 8 MHz. and retested. The results are shown in curve 42 in FIG. 3. The blown tag no longer triggered the alarm at a standard detector gate.

### Example 2

The tag was constructed as in Example 1. The switch composition 11 was formulated from a UV curing ink (Acheson PM025) containing 30 weight percent of the same nickel flake in example 1. The switch composition was dropped onto the substrate and cured with UV light. The testing was repeated and produced a similar trace to curve 41 in FIG. 3. This tag was found to trigger the alarm at the standard detector gate in Example 1. The tag was then passed over the tag blower used in Example 1. This resulted in a trace comparable to curve 42 in FIG. 3. The blown tag no longer triggered the alarm at a standard detector gate

### Example 3

The tag was constructed as in Example 1. The switch composition 11 was formulated from a solvent-containing ink (Polyplast PY made by Sericol) containing 10 weight percent of the same nickel flake in Example 1. The switch composition was dropped onto the substrate and cured with hot air drying. The testing was repeated and produced a similar trace to curve 41 in FIG. 3. This tag was found to trigger the alarm at the standard detector gate in Example 1. The tag was then passed over the tag blower used in Example 1. This resulted in a trace comparable to curve 42 in FIG. 3. The blown tag no longer triggered the alarm at a standard detector gate

### Example 4

The tag was constructed as in Example 1. The switch composition 11 was formulated from a solvent-containing ink (Polyplast PY made by Sericol) containing 40 weight percent of the same nickel flake in example 1. The switch composition was dropped onto the substrate and cured with hot air drying. The testing was repeated and produced a similar trace to curve 41 in FIG. 3. This tag was found to trigger the alarm at the standard detector gate in Example 1. The tag was then passed over the tag blower used in Example 1. This resulted in a trace comparable to curve 42 in FIG. 3. The blown tag no longer triggered the alarm at a standard detector gate

### Example 5

The tag was constructed as in Example 1. The switch composition 11 was formulated from a solvent-containing ink (Vynafresh vinyl varnish made by Coates screen) containing 25 weight percent of the zinc flake supplied by Novamet with a sieve size of −325 mesh (US standard mesh) and particle size 40 microns and 0.4 microns thick. The switch composition was dropped onto the substrate and cured with switch composition was dropped onto the substrate and cured with hot air drying. The testing was repeated and produced a similar trace to curve 41 in FIG. 3. This tag was found to trigger the alarm at the standard detector gate in Example 1. The tag was then passed over the tag blower used in Example 1. This resulted in a trace comparable to curve 42 in FIG. 3. The blown tag no longer triggered the alarm at a standard detector gate.

### Example 6

The tag was constructed as in Example 1. The switch composition 11 was formulated from a solvent-containing ink (Vynafresh vinyl varnish made by Coates screen) containing 40 weight percent of copper flake in the size range 18 to 24 microns supplied by Wolstenholme International Ltd which contains a submicron coating of stearic acid. The switch composition was dropped onto the substrate and cured with hot air drying. The testing was repeated and produced a similar trace to curve 41 in FIG. 3. This tag was found to trigger the alarm at the standard detector gate in example 1. The tag was then passed over the tag blower used in Example 1. This resulted in a trace comparable to curve 42 in FIG. 3. The blown tag, no longer triggered the alarm at a standard detector gate.

Other copper particles with a leafing layer that may also be used are Wolstenholmes copper at 14 and 10 micron flake nominally known as 3312, other available particles are lining grade 3424, fine lining 7544, or superfine lining 6524.

### Example 7

The tag was constructed as in Example 1. The switch composition 11 was formulated from a solvent-containing ink (Vynafresh vinyl varnish made by Coates screen) containing 50 weight percent of aluminium flake supplied either by Avery Dennison under the Brand name “Metalure” or alternatively Eternabrite 301. The switch composition was dropped onto the substrate and cured with hot air drying. The testing was repeated and produced a similar trace to curve 41 in FIG. 3. This tag was found to trigger the alarm at the standard detector gate in example 1. The tag was then passed over the tag blower used in Example 1. This resulted in a trace comparable to curve 42 in FIG. 3. The blown tag no longer triggered the alarm at a standard detector gate.

### Example 8

A tag was constructed in the form shown in FIGS. 4a-b. The metal tracks were of copper deposited by electroless plating and thickened by electroplating. The circuits on the two sides were connected by a contact hole at 45, which was through-plated by the process used to print the metal tracks.

The switch composition 51 contains a low metal loaded switch composition ink made using 10% loading of fine copper flake supplied by Wolstenholme international ltd. This was placed into wet PVA adhesive supplied by Unibond ltd. The ink was painted into the gap between the capacitor plate 43 and the further capacitor plate 49, in FIG. 4a, using a brush and stencil to an area of 2 mm² and dried at 60° C. for 10 minutes.

The tag was connected to a Hewlett Packard 4192A LF impedance analyzer and tested for impedance response to an applied signal over the frequency range 5 to 13 MHz The resulting trace is shown at curve 61 in FIG. 7a. This tag was found to trigger the alarm at a standard detector gate operating on a swept frequency around 8 MHz.

The tag was then passed over a “Crosspoint XRDA-3” tag blower which subjected it to swept high field strength at around 8 MHz. and retested. The results are shown in curve 62 in FIG. 7a. The low metal loaded tag was activated but caused a high resistance connection between the second and third capacitor plates 43 and 49. This effectively provides a damping effect on the resonant frequency. The tag, is considered blown, and would no longer trigger an alarm at a standard detector gate.

### Example 9

A further ink was formulated in accordance with example 8 with the same components and applied in the same way to the tag, except that 30% of the fine copper flake was added to the wet ink.

The tag was then passed over a “Crosspoint XRDA-3” tag blower which subjected it to swept high field strength at around 8 MHz. and retested. The presence of a high metal loaded ink, was able to introduce the further capacitor plate 49, at a low resistance. This provided a new resonant frequency FIG. 7b.

However, when the tag is subjected to a strong RF field which does not match the resonant frequency of the circuit, there is no activation of the switch composition, as shown in FIG. 7c.

1-39. (canceled)

40. An RF tag comprising a tuned circuit comprising an inductive coil on a first side of a substrate electrically connected to a first capacitor plate on the same side of the substrate as the inductive coil, said inductive coil being electrically connected to a second capacitor plate substantially aligned with the first capacitor plate but separated from the first capacitor plate by a dielectric layer, characterized in that the circuit also contains an insulating gap to which has been applied a switch composition whose conducting properties can be changed from an insulating state to a conducting state when the tag is subjected to a strong electric field at or around the resonant frequency of the tuned circuit.

41. An RF tag according to claim 40 wherein the dielectric layer is the substrate and the second capacitor plate is located on the second side of the substrate.

42. An RF tag according to claim 40 wherein the change in conductance of the switch composition causes a change in the resonant frequency of the tuned circuit.

43. An RF tag according to claim 40 wherein the insulating gap is between conductive tracks connected respectively to the first and second capacitor plates.

44. An RF tag according to claim 40 wherein the insulating gap is between either the first or the second capacitor plate and at least one further capacitor plate.

45. An RF tag according to claim 44 having a plurality of capacitor plates separated by successive insulating gaps to each of which has been applied a switch composition.

46. An RF tag according to claim 40 wherein the insulating gap is between turns of the inductive coil.

47. An RF tag according to claim 40 wherein the insulating gap is between the inductive coil and a further inductive coil.

48. An RF tag according to claim 47 having a plurality of further inductive coils which comprises further turns inside or outside the original inductive coil.

49. An RF tag according to claim 40 wherein the change of conductance introduces at least one further electrical component into the circuit.

50. An RF tag according to claim 49 wherein the further electrical component is an integrated circuit or memory chip.

51. An RF tag according to claim 40, wherein there are one or more tuned circuits.

52. An RF tag according to claim 40 wherein the dielectric material is selected from paper, polymers, polymer composites, ceramics or cured switch composition.

53. A switch composition suitable for an RF tag whose conducting properties can be changed from an insulating state to a conducting state when subjected to an electrical potential, wherein the switch composition comprises a binder and a plurality of conducting particles having an insulating surface layer, wherein substantially all of said particles are in contact with adjacent particles, such that when subjected to an electrical potential, the insulating surface layer is capable of breaking down to create a conducting path between the conducting particles.

54. A composition according to claim 53 wherein the thickness of the insulating surface layer is less than 1 micron.

55. A composition according to claim 54 wherein the thickness of the insulating layer is less than 100 nm.

56. A composition according to claim 55 wherein the thickness of the insulating layer is less than 50 nm.

57. A composition according to claim 53 wherein the conducting particles are selected from metal, metal alloy and metalloid particles.

58. A composition according to claim 57 wherein the metal is selected from aluminium, copper, titanium and nickel.

59. A composition according to claim 53 wherein the insulating surface layer is an organic polymer, a de-wetting agent or metal oxide.

60. A composition according to claim 59 wherein the insulating surface layer is stearic acid or oleic acid.

61. A composition according to claim 53 wherein the conducting particles are present in the range of from 5 to 75% w/w of the switch composition.

62. A composition according to claim 53 wherein the diameter of the conducting particles is in the range of from 0.1 to 1000 μm.

63. A composition according to claim 62 wherein the diameter of the conducting particles is in the range of from 1 to 100 μm.

64. A composition according to claim 53 wherein the non-conducting binder is polyvinyl alcohol, polyvinyl actetate, a polyamide, a polyether, a polyurethane, a UV curable monomer or oligomer, or a hotmelt adhesive.

65. An ink composition suitable for printing a switch composition comprising a printable ink, and a switch composition according to claim 53 and optionally a solvent.

66. An ink composition according to claim 65 wherein the ink composition is curable by thermal radiation.

67. An ink composition according to claim 65, wherein the ink composition is curable by ultra violet radiation.

68. An ink composition according to claim 65 wherein the ink further comprises a pigment, or other spectroscopically active material.

69. A data storage means comprising a plurality of RF tuned circuits, each of which possess a different resonant frequency, wherein one or more of said circuits are caused to change from a first resonant frequency to a second resonant frequency or non-resonant state, by subjecting said circuit to an RF frequency corresponding to its first resonant frequency, to create a unique combination of resonant frequencies.

70. A data storage means according to claim 69, wherein the one or more tuned circuits contains an insulating gap to which has been applied a switch composition, comprising a binder and a plurality of conducting particles having an insulating surface layer, wherein substantially all of said particles are in contact with adjacent particles, whose conducting properties can be changed from an insulating state to a conducting state when the tag is subjected to a strong electric field at or around the resonant frequency of the tuned circuit.

71. A method of activating a data storage means as defined in claim 69 comprising the steps of i) selecting a resonant frequency of one of the one or more circuits; ii) causing said circuit to change from a first resonant frequency to a second resonant frequency or non-resonant state; iii) repeating steps i) and ii), to subsequent one or more circuits, to cause a unique combination of resonant frequencies in said data storage means, optionally; iv) transmitting a plurality of low power RF signals capable of causing resonance in the plurality of tuned circuits in said RF tag; v) detecting the presence of said resonant frequencies.

72. An RF tag comprising a tuned circuit comprising an inductive coil on a first side of a substrate electrically connected to a first capacitor plate on the same side of the substrate as the inductive coil, said inductive coil being electrically connected to a second capacitor plate substantially aligned with the first capacitor plate but separated from the first capacitor plate by a dielectric layer, characterized in that the circuit also contains an insulating gap to which has been applied a switch composition, wherein the switch composition comprises a binder and a plurality of conducting particles having an insulating surface layer, wherein substantially all of said particles are in contact with adjacent particles, such that when subjected to an electrical potential, the insulating surface layer is capable of breaking down to create a conducting path, such that in use, said conducting properties can be changed from an insulating state to a conducting state when the tag is subjected to a strong electric field at or around the resonant frequency of the tuned circuit.
